(19) United States
(12) Patent Application Publication
(10) Pub. No.: US 2013/0287325 A1
(43) Pub. Date: Oct. 31, 2013

(54) Bearing Arrangement For A Crankshaft Of An Internal Combustion Engine

(71) Applicants: Robert Stocker, Muenster (DE); Niels P. Lange, Augsburg (DE); Heribert Imkamp, Augsburg/Stadtbergen (DE)

(72) Inventors: Robert Stocker, Muenster (DE); Niels P. Lange, Augsburg (DE); Heribert Imkamp, Augsburg/Stadtbergen (DE)

(73) Assignee: MAN DIESEL & TURBO SE, Augsburg (DE)

(21) Appl. No.: 13/820,535

(22) PCT Filed: Sep. 2, 2011
(86) PCT No.: PCT/EP2011/065207

§ 371 Date: Jul. 17, 2013

(30) Foreign Application Priority Data
Sep. 3, 2010 (DE) 10 2010 040 244.3

(51) Int. Cl. F16C 9/02

(52) U.S. Cl. CPC F16C 9/02
USPC 384/129

(57) ABSTRACT

A crankshaft bearing of a crankshaft of an internal combustion engine has a plain bearing formed of bearing shells, wherein a bearing shell (10) adjoins a cylinder crankcase (11) of the internal combustion engine by a bearing shell back (13) and adjoins the crankshaft to be bearing-supported by a bearing shell running surface (12), wherein either the bearing shell running surface (12) or the bearing shell back (13) or a surface (14) of the cylinder crankcase (11) adjoining the bearing shell back (13) has a concave profile.

### PRIORITY CLAIM

This is a U.S. national stage of application No. PCT/EP2011/065207, filed on Sep. 2, 2011. Priority is claimed on the following application(s): Country: Germany, Application No.: 10 2010 040 244.3 , Filed: Sep. 3, 2010, the entire content of which is incorporated herein by reference.

### FIELD OF THE INVENTION

The invention is directed to a crankshaft bearing of a crankshaft of an internal combustion engine.

### BACKGROUND OF THE INVENTION

A crankshaft bearing of a crankshaft is often also referred to as a main bearing and serves to support and hold the crankshaft in the cylinder crankcase of the internal combustion engine. A crankshaft bearing usually comprises a plain bearing made up of a plurality of bearing shells which are received in a base bore of the cylinder crankcase. The base bore of the cylinder crankcase in which the bearing shells of the plain bearing are inserted is typically formed by a so-called bearing block which is part of the cylinder crankcase and by a so-called bearing cover which is likewise part of the cylinder crankcase. The plain bearing of a crankshaft bearing arrangement of this kind is oil-lubricated to ensure the least possible wear of the crankshaft bearing.

In a conventional crankshaft bearing, the maximum bearing load for the plain bearing and bearing shells thereof occurs approximately in the axial center of the bearing during operation of the crankshaft bearing. Consequently, the plain bearings of common crankshaft bearing arrangements are subject to a sharply varying or different load considered along the axial width of the bearing. Further, because of the aforementioned pressure distribution, the highest bearing temperature occurs approximately in the center of the axial width of the bearing. Since there is a direct relationship between the bearing temperature and the life of the bearing material, a local peak temperature approximately in the axial center of the plain bearing limits the life of the crankshaft bearing in its entirety. This is disadvantageous.

### SUMMARY OF THE INVENTION

There is a need for a crankshaft bearing in which the pressure distribution and temperature distribution can be made uniform over the axial width of the bearing. On this basis, it is an object of the invention is to provide a novel crankshaft bearing of a crankshaft of an internal combustion engine.

According to the invention, either the running surface of the bearing shell or the back of the bearing shell or a surface of the cylinder crankcase adjoining the back of the bearing shell has a concave profile.

It is suggested for the first time with the present invention to provide a running surface of the bearing shell or a back of the bearing shell of a plain bearing of a crankshaft bearing or a surface of the cylinder crankcase adjoining the back of the bearing shell with a concave profile. By means of this concave profiling, a bearing load, namely, a pressure load and temperature load, can be homogenized along the axial bearing width.

In this way, it is possible to prolong the life of a crankshaft bearing without changing the bearing dimensions. Alternatively, the dimensions and therefore the size of a crankshaft bearing can be reduced, while the lifetime of the crankshaft bearing remains the same.

### BRIEF DESCRIPTION OF THE DRAWINGS

Embodiment examples of the invention are described more fully with reference to the drawings in which:

FIG. 1 is a schematic cross sectional view through a crankshaft bearing of a crankshaft of an internal combustion engine according to a first embodiment example of the invention;

FIG. 2 is a schematic cross sectional view through a crankshaft bearing of a crankshaft of an internal combustion engine according to a second embodiment example of the invention; and

FIG. 3 is a schematic cross sectional view through a crankshaft bearing of a crankshaft of an internal combustion engine according to a third embodiment example of the invention.

### DETAILED DESCRIPTION OF THE PRESENTLY PREFERRED EMBODIMENTS

The present invention is directed to a crankshaft bearing of a crankshaft of an internal combustion engine. A crankshaft bearing of this kind serves to support and hold the crankshaft in a cylinder crankcase of the internal combustion engine. The crankshaft bearing comprises a plain bearing which is typically formed of a plurality of bearing shells, namely, a top bearing shell and a bottom bearing shell. These bearing shells are inserted into a bore in the cylinder crankcase.

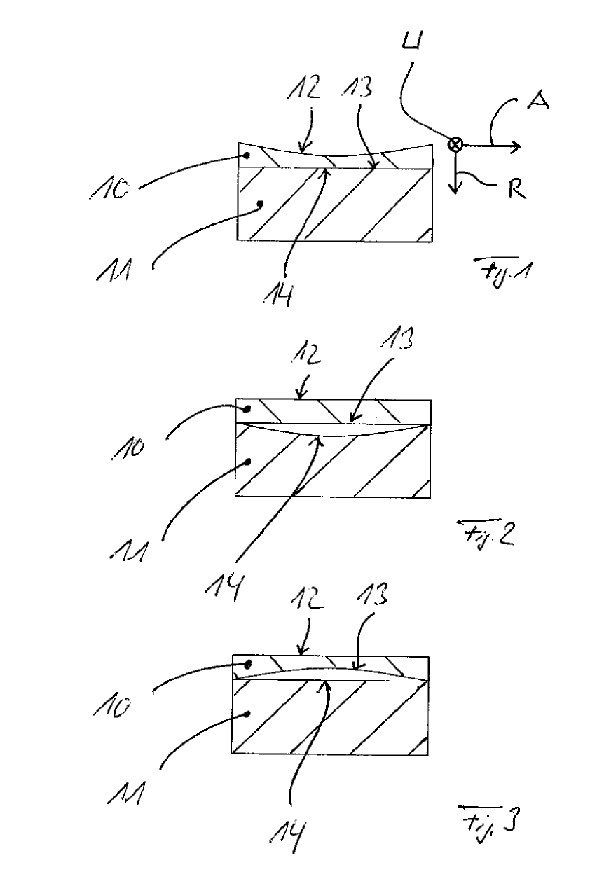

FIG. 1 shows a highly schematic partial cross section through a crankshaft bearing of a crankshaft, not shown, with a section direction in axial direction of the crankshaft bearing; a cross section through a bearing shell 10, namely, through a bottom bearing shell 10, of the crankshaft bearing and a cross section through a portion of a cylinder crankcase 11 of the internal combustion engine adjoining the bottom bearing shell 10 are shown. The bottom bearing shell 10 shown in axial cross section in FIG. 1 has a running surface 12 which adjoins the crankshaft to be bearing-supported while forming a gap. A so-called bearing shell back 13 by which the bearing shell 10 adjoins a surface 14 of the portion of the cylinder crankcase 11 adjoining the bottom bearing shell 10 is formed at a side of the bearing shell 10 located opposite the bearing shell running surface 12.

As was already stated, FIG. 1 shows a cross section in axial direction through the bottom bearing shell 10 of the plain bearing of the crankshaft bearing arrangement and through the portion of the cylinder crankcase 11 that adjoins the bottom bearing shell 10. Axial direction A is shown in FIG. 1. FIG. 1 further shows a radial direction R and a circumferential direction U. The circumferential direction U extends into and out of the drawing plane.

In the embodiment example of FIG. 1, the running surface 12 of the bearing shell 10 is provided with a concave profile. The concave profile of the bearing shell running surface 12 is circumferential seen in circumferential direction of the bearing shell 10 and extends both in radial direction and in axial direction.

It can be seen from FIG. 1 that the concave curve profile of the bearing shell running surface 12 in radial direction is formed in such a way that the radial curve depth of the concave profile is lowest in the axial center of the bearing shell 10, and this radial curve depth decreases continuously in direction of the axial edges of the bearing shell 10.

A pressure load and a temperature load can be homogenized over the axial width of the bearing shell 10 by means of the above-mentioned profiling of the running surface 12 of the bottom bearing shell 10 of the plain bearing of a crankshaft bearing arrangement so that local pressure peaks and temperature peaks along the axial width of the bearing shell 10 can accordingly be decreased or even prevented. The lifetime of crankshaft bearings can be positively influenced in this way.

Further, the concave profile of the running surface 12 of the bottom bearing shell 10 can improve a tangential oil flow in the plain bearing of the crankshaft bearing arrangement according to the invention, which ultimately leads to an improved dissipation of heat at the bottom bearing shell 10. In this way, the temperature load on the bottom bearing shell 10 can be further reduced and, therefore, the lifetime further increased.

Accordingly, by increasing the oil flow in tangential circumferential direction, lubricating oil is conveyed from the highly loaded region of the bottom bearing shell 10 into a less loaded region of a top bearing shell, not shown. The oil can freely exit the bearing in axial direction in the region of the top bearing shell in which a gap occurring between the bearing shell and the crankshaft is larger than in the region of the bottom bearing shell because of the displacement path of the crankshaft.

In this way, it is ensured that an unimpeded exchange of lubricating oil is possible in spite of a throttling of the oil flow in axial direction that is caused by the concave contouring of the bottom bearing shell 12, and a good cooling of the crankshaft bearing is accordingly guaranteed.

In contrast to the preferred embodiment example of the invention shown in FIG. 1 in which the running surface 12 of the bottom bearing shell 10 has the concave profile, it is also possible for the surface 14 of the cylinder crankcase 11 adjoining the back 13 of the bearing shell to be provided with the concave profile as is shown in FIG. 2. Alternatively, as is shown in FIG. 3, the back 13 of the bearing shell can be provided with the concave profile. The bearing shell (without profile) shown in FIGS. 2 and 3 then first adopts a concave bearing running surface in the installed and tensioned state, i.e., the state shown in FIG. 1.

In the embodiments in FIGS. 2 and 3, the pressure load and temperature load can be homogenized along the axial width of the bearing and an increased oil flow in tangential circumferential direction can be achieved in case of FIGS. 2 and 3.

The life of crankshaft bearings can be increased by the invention. The lifetime of the crankshaft bearing can be prolonged while maintaining the same dimensions. Alternatively, the invention can also be used to reduce the dimensions of a crankshaft bearing while maintaining the lifetime thereof and thus to provide a more compact engine architecture through a shorter engine length and narrower bearing. Further, an enhanced performance of an internal combustion engine can be realized in this way.

According to an advantageous further development of the invention, the concave profile varies considered in circumferential direction. According to this advantageous further development, it is possible, for example, that the radial curve depth of the concave curve profile varies considered in circumferential direction. The characteristics of the crankshaft bearing can be further improved in this way.

Alternatively, it is also possible that the concave profile does not vary considered in circumferential direction.

Preferably, exclusively a bottom bearing shell 10 of the plain bearing or a portion of the cylinder crankcase 11 adjoining the bottom bearing shell 10 of the plain bearing has the concave profile, whereas a concave profile of this kind is not formed in the region of the top bearing shell or in the region of a portion of the cylinder crankcase adjoining the top bearing shell.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A crankshaft bearing of a crankshaft of an internal combustion engine comprising a plain bearing formed of bearing shells, said bearing shell adjoining a cylinder crankcase of the internal combustion engine by a bearing shell back and adjoining the crankshaft to be bearing-supported by a bearing shell running surface; and wherein either the bearing shell running surface or the bearing shell back or a surface of the cylinder crankcase adjoining the bearing shell back has a concave profile.

9. The crankshaft bearing according to claim 8, characterized in that the concave profile is circumferential in circumferential direction.

10. The crankshaft bearing according to claim 8, characterized in that the concave profile varies in circumferential direction.

11. The crankshaft bearing according to claim 8, wherein the concave profile does not vary in circumferential direction.

12. The crankshaft bearing according to claim 8, wherein a concave curve profile of the concave profile extends in radial direction and axial direction.

13. The crankshaft bearing according to claim 12, wherein the concave curve profile is formed such that the radial curve depth thereof is deepest in the axial center.

14. The crankshaft bearing according to claim 8, wherein the concave profile is exclusively disposed at one of a bottom bearing shell of the plain bearing and a portion of the cylinder crankcase adjoining the bottom bearing shell of the plain bearing.

15. The crankshaft bearing according to claim 9, characterized in that the concave profile varies in circumferential direction.

16. The crankshaft bearing according to claim 9, wherein the concave profile does not vary in circumferential direction.

17. The crankshaft bearing according to claim 9, wherein a concave curve profile of the concave profile extends in radial direction and axial direction.

18. The crankshaft bearing according to claim 10, wherein a concave curve profile of the concave profile extends in radial direction and axial direction.

19. The crankshaft bearing according to claim 9, wherein the concave profile is exclusively disposed at one of a bottom bearing shell of the plain bearing and a portion of the cylinder crankcase adjoining the bottom bearing shell of the plain bearing.

20. The crankshaft bearing according to claim 10, wherein the concave profile is exclusively disposed at one of a bottom bearing shell of the plain bearing and a portion of the cylinder crankcase adjoining the bottom bearing shell of the plain bearing.

21. The crankshaft bearing according to claim 11, wherein the concave profile is exclusively disposed at one of a bottom bearing shell of the plain bearing and a portion of the cylinder crankcase adjoining the bottom bearing shell of the plain bearing.
